(19) United States
(12) Patent Application Publication
(10) Pub. No.: US 2003/0124041 A1
(43) Pub. Date: Jul. 3, 2003

(54) Process for removing nitrogen oxides from gases

(75) Inventors: Hartmut Neumann, Munchen (DE); Ulrike Wenning, Karlsfeld (DE)

Correspondence Address: CROWELL & MORING, LLP, Intellectual Property Group, P.O. Box 14300, Washington, DC, 20044-4300, US

(73) Assignee: Linde Aktiengesellschaft

(21) Appl. No.: 10/326,970

(22) Filed: Dec. 24, 2002

Related U.S. Application Data
(63) Continuation of application No. 09/093,886, filed on Jun. 9, 1998, now abandoned.

(30) Foreign Application Priority Data
Jun. 9, 1997 (DE) 197 24 286.3

(51) Int. Cl. C01B 21/00

(52) U.S. Cl. 423/235

(57) ABSTRACT

The invention relates to a process for removing nitrogen oxides from a fluid, the fluid being the feed air or a product or product mixture or a process fluid of an air separation plant. According to the invention, the nitrogen oxides are removed by chemisorption on metal oxides.

The metal oxides are preferably formed from metals of the 6th to 8th subgroup, manganese dioxide (MnO₂) being particularly preferred as the metal oxide. The process can comprise one or more reactor beds, which are preferably operated at 10 to 40° C. and are regenerated with nitrogen at a temperature from 130 to 170° C. The process can be used for the recovery of gases of extreme purity, for example for the manufacture of semiconductors.

The invention relates to a process for removing nitrogen oxides from a fluid, the fluid being the feed air or a product or product mixture or a process fluid of an air separation plant.

The removal of nitrogen oxides from such gas streams is necessary because the demands on the purity of the products of an air separation plant (ASP) are becoming increasingly stringent. This applies in particular to users of these products, such as, for example, manufacturers of semiconductors. Particularly at low temperatures below 0° C., such as occur in the low-temperature part of an ASP, a reaction of the NO with the atmospheric oxygen also takes place to give N₂O₃ having a boiling point at −102° C. and N₂O₄ having a boiling point at −11° C., and these nitrogen oxides can accumulate in the low-temperature section of the ASP and, in the solid form, can cause blockages. Moreover, increased nitrogen oxide contents in the air are frequently measured on industrial sites, and the design of the ASP must be based on up to 6 mol ppm in the air drawn in.

A part of the nitrogen oxides can be removed during prepurification of the air and, in this case, does not pass into the low-temperature section of the ASP. Even then, however, a small part can cause blockages or contribute to contamination of the ASP products.

If an adsorption unit is used for the prepurification, the quantity of adsorbent, corresponding to the impurities in the air, must be calculated mainly in accordance with the CO₂ concentration, and NO is not completely adsorbed. In addition, NO also tends to form explosive compounds with other chemical compounds, for example unsaturated hydrocarbons or NH₃, and these can cause damage in the ASP. Moreover, together with atmospheric moisture, the nitrogen oxides form acids which can damage the adsorbent and other components of the ASP. These acids lead to ageing of the adsorber bed used for purifying the air and to corrosion in the plant.

It is therefore the object of the invention to prevent the negative effects of the nitrogen oxides in the ASP.

According to the invention, this object is achieved by a process in which the nitrogen oxides are removed by chemisorption on metal oxides. Particularly advantageous embodiments of the invention are the subject of subclaims.

The removal of nitrogen oxides from gases is known per se. In the printed publication: Hamid Arastoopour and Hossein Hariri, NOₓ Removal with High-Capacity Metal Oxides in the Presence of Oxygen, Ind. Eng. Chem. Process Des. Dev. 1981, 20, pages 223-228, a process for the purification of flue gases is described. For this purpose, the chemisorption of nitrogen monoxide on manganese dioxide, based on the following chemical reaction equation:

MnO₂+2NO+O₂⇄Mn(NO₃)₂

is exploited. In this case, the equilibrium at high temperatures (T>100-150° C.) is on the left-hand side of the equation, so that thermal regeneration is possible.

In addition to the reaction mentioned by Arastoopour, the following chemical reaction of the manganese dioxide with nitrogen dioxide is also possible:

MnO₂+2NO₂⇄Mn(NO₃)₂

In the printed publication quoted, the process is described as being disadvantageous, since the absorption capacity of MnO₂ is low. This disadvantage is, however, unimportant for the use in the purification of the inlet gas and of the product and process gases of an ASP, since the NOₓ concentration at a few mol ppm is substantially smaller than in the case of flue gases with, for example, 500-1000 mol ppm. Surprisingly, however, NOₓ can be removed with high efficiency even at low concentrations, even though, considered kinetically, the probability of a successful conversion is lower by a factor of >10⁴.

The purification of air or of gases recoverable from the air by removal of nitrogen oxides impurities within the range of a few mol ppm at temperatures below 100° C. down to the range of ambient temperature in a reactor with MnO₂ has so far not been considered by those skilled in the art. From the point of view of cost, however, the operation at ambient temperature is of interest. Surprisingly, laboratory experiments, for example using the catalyst T 2525 made by Südchemie, consisting of MnO₂ on alumina, and other MnO₂-containing catalysts on another support material, have shown that traces of NO are absorbed with a high yield at ambient temperature.

The carrier gas can also be oxygen or preferably contains at least traces of oxygen, since oxygen promotes the chemisorption of nitrogen oxides. It can, for example, also be a rare gas.

With advantage, metal oxides of metals of the 6th to 8th subgroup of the Periodic Table of the Elements, in particular commercially available catalysts, can be used in the process according to the invention. Preferably, it is manganese dioxide, on its own or as a mixture of the oxides of said metals, that preferably is applied to particles with a support material such as alumina or silica.

For the absorption of nitrogen oxides, an operating temperature below 100° C., preferably between 0 and 100° C., is advantageous, and a temperature between 3 and 40° C. is particularly advantageous.

Favourable space velocities for the chemisorption of nitrogen oxides are between 300 h⁻¹ and 12000 h⁻¹, in particular between 500 and 8000 h⁻¹.

In the reactor bed, through which the process gas flows, the chemisorption of the nitrogen oxides on MnO₂ takes place, the latter being converted thus to Mn(NO₃)₂. The removal of nitrogen oxides is with advantage carried out in one or more reactor beds which contain manganese dioxide or a material containing manganese dioxide or coated with manganese dioxide, the reactor bed effecting the chemisorption of the nitrogen oxides and being regenerated before a limiting load is reached.

For regeneration, a warm gas, which has no reactive effect in this connection, preferably nitrogen, advantageously flows through the reactor bed at a temperature from 100 to 300° C., preferably 130 to 170° C.

The design of the equipment for removing nitrogen oxides from gases depends on the overall conditions of the application. For the removal of traces of nitrogen oxides in orders of magnitude below 0.1 mol ppm, or if nitrogen oxides are only sporadically present in the carrier gas or if pauses of appropriate length in the operation make this possible, a single reactor bed can advantageously be used.

If continuous operation of the equipment is necessary, preferably a plurality of reactor beds, but at least two, are used. At least one reactor bed then undertakes the chemisorption, and the other reactor bed or beds are regenerated. The reactor beds used undertake the chemisorption one after the other, so that continuous nitrogen oxide removal becomes possible.

The metal oxide can be employed in particulate form in such a way that the particles form a layer in the bed of a reactor, absorber or preferably adsorber or are mixed with other particles of the bed. The advantage is then that a single bed fulfils a plurality of functions or even, if it is an adsorber bed, it can be regenerated together with particles of the adsorber.

The process can be employed with advantage for the recovery of gases of extreme purity, for example for the manufacture of semiconductors. Reactive constituents such as the nitrogen oxides must be removed down to traces in the lower mol ppb range from such gases of extreme purity.

### EXAMPLE 1

With an MnO₂-containing catalyst made by Südchemie, type 2525 with MnO₂ on Al₂O₃, laboratory experiments at room temperature and atmospheric pressure and with the following data:

| | |
|---|---|
| space velocity | about 4000 h⁻¹ |
| NO content | 20 mol ppb |
| O₂ content | 500 mol ppm |
| remainder | N₂, CO, H₂, hydrocarbons |

result after 200 running hours in a removal of NO down to a residual NO content of 2 mol ppb. In this laboratory experiment, the space velocity of about 4000 h⁻¹ was adjusted such that about 100 l/h of the NO-containing gas were passed over 25 ml of MnO₂-containing material. In principle, even lower residual NO contents can be reached with different operating data.

What is claimed is:

1. A process for removing nitrogen oxides from a fluid comprising removing the nitrogen oxides by chemisorption on metal oxides.

2. A process according to claim 1, wherein said fluid is the feed air or a product or product mixture or a process fluid of an air separation plant.

3. A process according to claim 2, wherein said fluid is nitrogen or oxygen or contains oxygen or is a rare gas.

4. A process according to claim 1, wherein the metals forming the metal oxides are metals of Groups VI to VIII of the Periodic Table of the Elements.

5. A process according to claim 4, wherein said metal oxide comprises manganese dioxide.

6. A process according to claim 5, wherein said manganese dioxide is mixed with the oxides of at least one other said metal.

7. A process according to claim 4, wherein said metal oxide is on a support material.

8. A process according to claim 7, wherein said support material is alumina or silica.

9. A process according to claim 1, wherein said nitrogen oxides are removed at a temperature below 100° C.

10. A process according to claim 4, wherein said temperature is between 0 and 100° C.

11. A process according to claim 10, wherein said temperature is between 3 and 40° C.

12. A process according to claim 9, wherein said nitrogen oxides are removed at a space velocity of between 300 and 12000 h^{-1.}

13. A process according to claim 12, wherein said space velocity is between 500 and 8000 h⁻¹.

14. A process according to claim 1, comprising removing said nitrogen oxides in one or more reactor beds which contain manganese dioxide or a material containing manganese dioxide or coated with manganese dioxide, and regenerating said reactor bed before a limiting load is reached.

15. A process according to claim 14, comprising flowing a non-reactive gas, through the reactor bed to be regenerated at a temperature of 100 to 300° C.

16. A process according to claim 15, wherein said non-reactive gas is nitrogen.

17. A process according to claim 15, wherein said temperature is 130 to 170° C.

18. A process according to claim 15, wherein only one reactor bed is used when (A) nitrogen oxides are present in the carrier gas in traces of less than 0.1 mol ppm, (B) when the process is conducted for only a short period, or (C) if there are pauses in the operation enabling the reactor bed to be regenerated.

19. A process according to claim 15, further comprising connecting at least two reactor bed in such a way that continuous operation of the nitrogen oxides' removal is achieved by the reactor beds alternately undertaking the chemisorption of the nitrogen oxides while at the same time the other reactor bed or beds are regenerated.

20. A process according to claim 1, wherein the metal oxide is employed in particulate form such that the particles form a layer in the bed of a reactor, absorber or adsorber or are mixed with other particles of the bed.

21. A process according to one claim 1, further comprising recovering gases of extreme purity.

22. A process according to claim 21, wherein said gas of extreme purity is intended for the manufacture of semiconductors.
